(19) United States
(12) Patent Application Publication
(10) Pub. No.: US 2013/0286483 A1
(43) Pub. Date: Oct. 31, 2013

(54) OPTICAL SHUFFLE SYSTEM HAVING A LENS FORMED OF SUB-WAVELENGTH GRATINGS

(71) Applicants: Marco Fiorentino, Mountain View, CA (US); David A. Fattal, Mountain View, CA (US); Raymond G. Beausoleil, Redmond, WA (US)

(72) Inventors: Marco Fiorentino, Mountain View, CA (US); David A. Fattal, Mountain View, CA (US); Raymond G. Beausoleil, Redmond, WA (US)

(21) Appl. No.: 13/458,854

(22) Filed: Apr. 27, 2012

(51) Int. Cl. G02B 5/18; B23P 11/00

(52) U.S. Cl. 359/566; 29/428; 29/407.1

(57) ABSTRACT

An optical shuffle system includes a plurality of sources that are to output respective beams of light and a plurality of receivers that are to receive respective beams of light, wherein the plurality of receivers are spaced apart from the plurality of sources. The optical shuffle system further includes an output lens formed of a plurality of output sub-wavelength grating (SWG) sections, wherein each of the plurality of output SWG sections is positioned in a respective output optical path of the plurality of sources, and wherein each of the plurality of output SWG sections is to collimate and direct light received from respective ones of the plurality of sources toward respective ones of the plurality of receivers.

### CROSS-REFERENCE TO RELATED APPLICATIONS

The present application has the same Assignee and shares some common subject matter with U.S. Patent Application Publication No. 2011/0261856, filed on Apr. 26, 2010, and titled “VERTICAL-CAVITY SURFACE-EMITTING LASER”, and U.S. patent application Ser. No. 13/384,725, filed on Jan. 18, 2012, and titled “OPTICAL DEVICES BASED ON DIFFRACTION GRATINGS”, the disclosures of which are hereby incorporated by reference in their entireties.

### BACKGROUND

Optical sources, such as, optical engines, are typically coupled to optical receivers through optical fibers. Conventional networking equipment often contain a large number of optical sources coupled to an equally large number of optical receivers through optical fibers.

### BRIEF DESCRIPTION OF THE DRAWINGS

Features of the present disclosure are illustrated by way of example and not limited in the following figure(s), in which like numerals indicate like elements, in which:

FIG. 1A shows an isometric view of an optical shuffle system, according to an example of the present disclosure;

FIG. 1B shows a simplified side view of the optical shuffle system 100 depicted in FIG. 1A, according to an example of the present disclosure;

FIGS. 1C and 1D, respectively, show diagrams of beams of light that are collimated and re-directed through sub-wavelength grating sections, according to examples of the present disclosure;

FIG. 1E shows a diagram of a manner in which the direction in which a beam of light is emitted is varied, according to an example of the present disclosure;

FIG. 2A shows a frontal view of a lens composed of a plurality of SWG sections formed as one dimensional sub-wavelength grating patterns in the lens, according to an example of the present disclosure;

FIGS. 2B and 2C, respectively, show frontal views of a lens composed of a plurality of SWG sections formed as two dimensional sub-wavelength grating patterns in the lens, according to two examples of the present disclosure;

FIG. 3 shows a cross-sectional view of ridges from two separate grating sub-patterns revealing the phase acquired by transmitted light, according to an example of the present disclosure;

FIG. 4 shows a cross-sectional view of the ridges depicted in FIG. 3 revealing how the transmitted wavefront changes, according to an example of the present disclosure;

FIG. 5 shows an isometric view of a phase change contour map produced by a particular grating pattern of a sub-wavelength grating, according to an example of the present disclosure;

FIGS. 6A and 6B, respectively, show cross-sectional views of sub-wavelength gratings that are designed and fabricated to vary a wavefront of light transmitted through the sub-wavelength gratings, according to examples of the present disclosure;

FIG. 7 shows a plot of transmittance and phase shift simulation results over a range of incident light wavelengths for a sub-wavelength grating section having a particular sub-wavelength grating pattern, according to an example of the present disclosure;

FIG. 8 shows a plot of transmittance and phase shift as a function of the sub-wavelength grating layer duty cycle for light with a wavelength of approximately 800 nm, according to an example of the present disclosure;

FIG. 9 shows a contour plot of phase variation as a function of period and duty cycle, according to an example of the present disclosure;

FIG. 10 shows a flow diagram of a method for fabricating an optical shuffle system, according to an example of the present disclosure; and

FIG. 11 shows a schematic representation of a computing device, which may be employed to perform some of the operations in the method depicted in FIG. 10, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

In the following description, the term “light” refers to electromagnetic radiation with wavelengths in the visible and non-visible portions of the electromagnetic spectrum, including infrared and ultra-violet portions of the electromagnetic spectrum.

Disclosed herein are optical shuffle systems and a method for fabricating an optical shuffle system. The optical shuffle system includes an output lens formed of a plurality of output sub-wavelength grating (SWG) sections and an input lens formed of a plurality of input SWG sections. Each of the output SWG sections is to be positioned in a respective output optical path of a plurality of sources and each of the input SWG sections is to be positioned in a respective optical path between a SWG section and a target receiver. The output SWG sections and the input SWG sections are to direct light beams emitted from the sources to respective intended ones of the receivers. In this regard, various ones of the output SWG sections have different physical characteristics, such as, ridge patterns, with respect to each other to vary the amount of deviation that light beams undergo as they are transmitted through the various ones of the output SWG sections. Likewise, various ones of the input SWG sections have different physical characteristics with respect to each other.

The SWG sections may be formed into the input lens and the output lens through relatively simple and inexpensive techniques, such as lithography. In addition, by forming the plurality of SWG sections, in which various ones of the SWG sections have different physical characteristics, on a single sheet to form one of the output lens and the input lens, the output lens and the input lens may be fabricated through relatively easy and inexpensive fabrication techniques. In addition, output lenses and input lenses having differently configured SWG sections may relatively easily be fabricated and implemented in an optical shuffle system as the target receivers for the sources vary.

Through implementation of the optical shuffle system and method disclosed herein, various configurations of sources and receivers may readily be optically coupled to each other. In addition, changes in the configurations, such as, source to target receivers, physical rearrangement of the receivers with respect to the sources, etc., of the sources and the receivers may readily be accommodated through fabrication and implementation of newly configured sets of output and input lenses. Alternatively, the output and input lenses may be fabricated to include additional SWG sections having different configurations to accommodate the changes in configurations of the sources and the receivers, such as, a rearrangement of the target receivers that are to receive light beams from the sources.

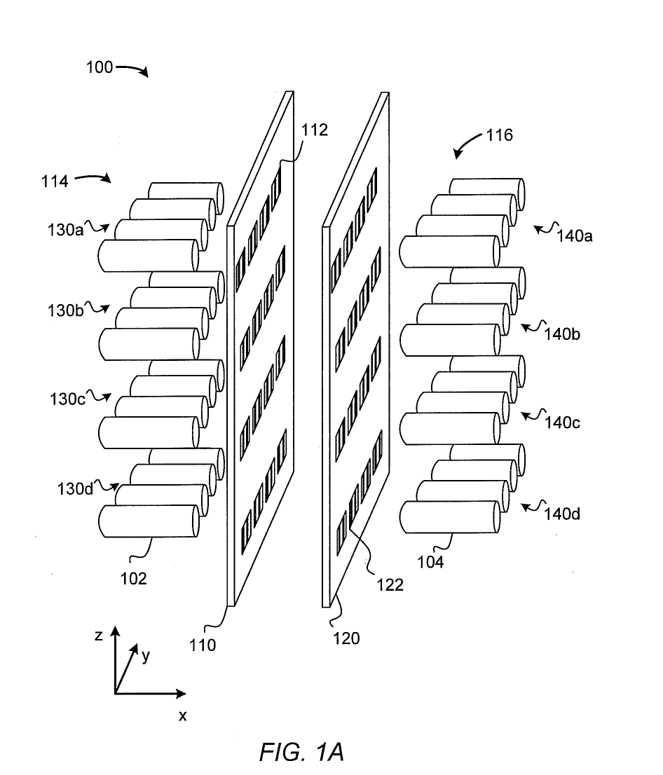

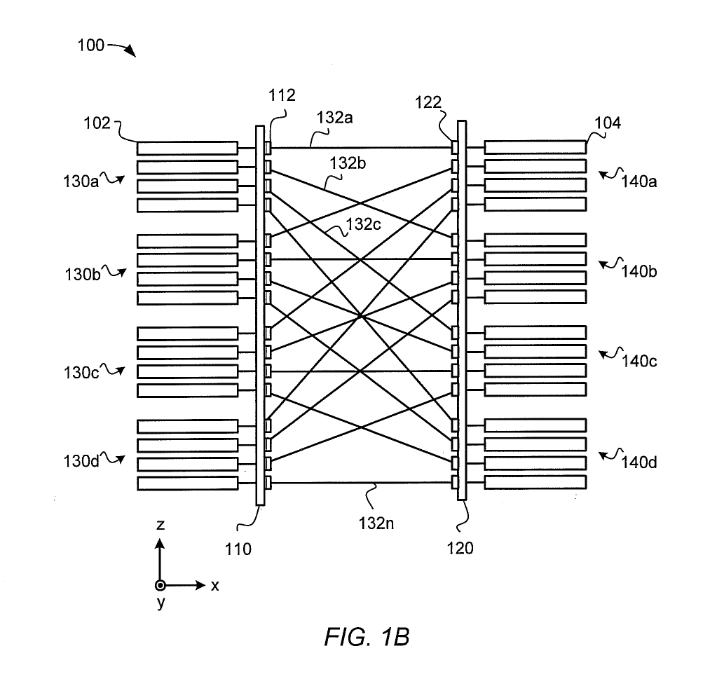

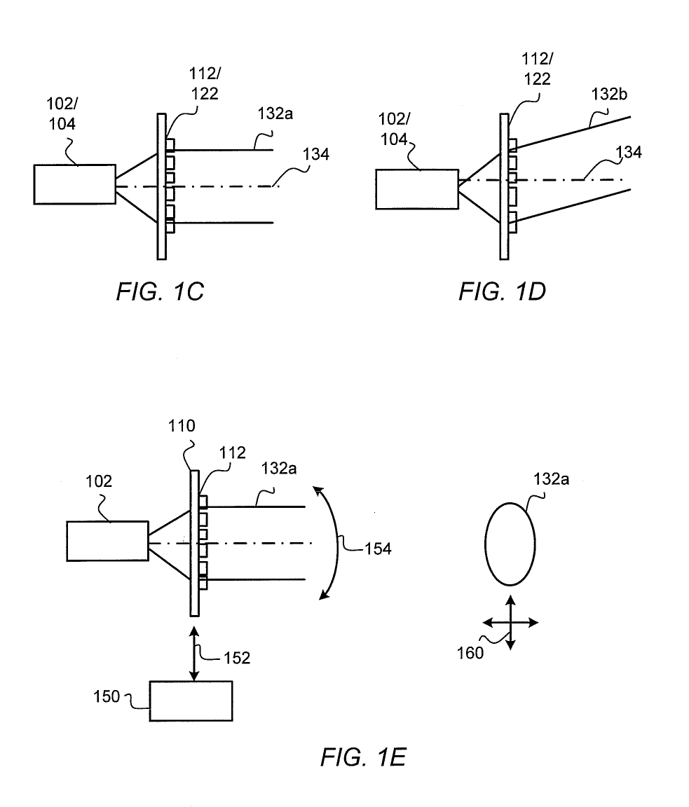

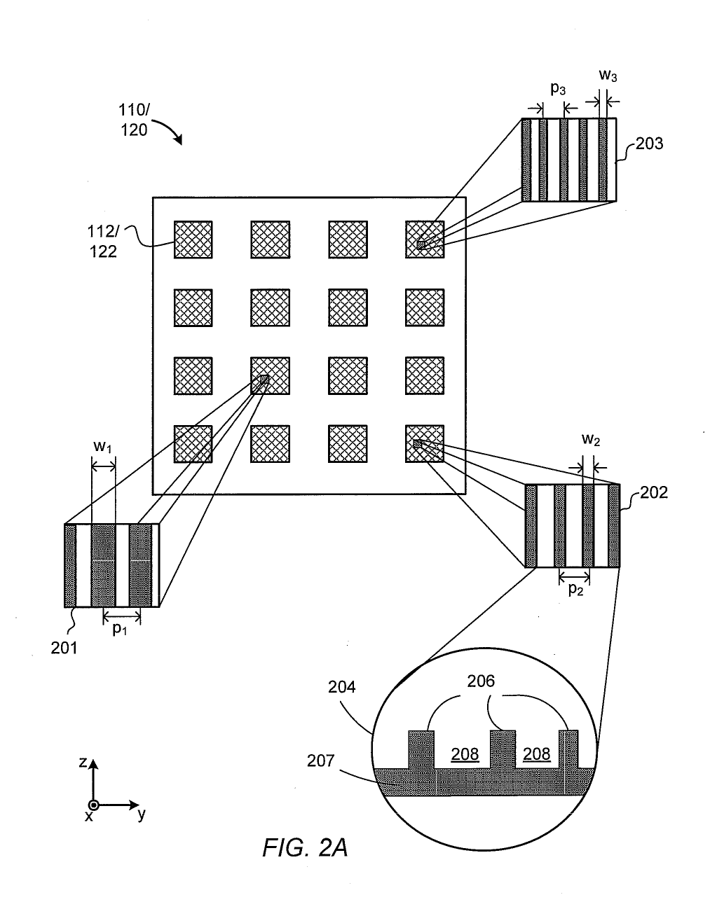

With reference first to FIG. 1A, there is shown an isometric view of an optical shuffle system 100, according to an example. It should be understood that the optical shuffle system 100 depicted in FIG. 1A may include additional components and that some of the components described herein may be removed and/or modified without departing from a scope of the optical shuffle system 100. In addition, it should be understood that the optical shuffle system 100 has not been drawn to scale, but instead, has been drawn to clearly show the relationships between the various components of the optical shuffle system 100.

As shown in FIG. 1A, the optical shuffle system 100 includes a plurality of sources 102 and a plurality of receivers 104, which are in a spaced relationship with respect to each other. The optical shuffle system 100 also includes an output lens 110 and an input lens 120 positioned between the sources 102 and the receivers 104. A plurality of output sub-wavelength grating (SWG) sections 112 are depicted as being formed on the output lens 110 and a plurality of input SWG sections 122 are depicted as being formed on the input lens 120. Although not shown, the output lens 110 and the input lens 120 may be maintained at substantially fixed locations with respect to the sources 102 and the receivers 104 through use of any suitable mechanical supports. Alternatively, the output lens 110 may be connected to an actuator (not shown) that is to vary the positions on the output lens 110 with respect to the sources 102 and the receivers 104. As a yet further alternative, both the output lens 110 and the input lens 120 may be connected to the actuator.

The sources 102 are depicted as being arranged in a plurality of source clusters 130a-130d and the receivers 104 are depicted as being arranged in a plurality of receiver clusters 140a-140d. According to an example, the sources 102 contained in a particular source cluster 130a comprise the sources of a particular device (not shown) and the receivers 104 contained in a particular receiver cluster 140a comprise the receivers of another particular device (not shown). Although the sources 102 and the receivers 104 have been depicted as being arranged in respective two dimensional arrays 114 and 116, it should be understood that either or both of the arrays 114 and 116 may instead be one dimensional arrays or three dimensional arrays.

As described in greater detail herein below, the input and output SWG sections 112, 122 have various physical characteristics, for instance, ridge spacings, ridge widths, ridge thicknesses, etc. The physical characteristics of the input and output SWG sections 112, 122 have various patterns to vary phase shifts of light transmitted through the input and output SWG sections 112, 122. More particularly, the patterns are designed to cause light to be transmitted in predetermined spatial modes across the output SWG sections 112 and directed by the input SWG sections 122. Various manners in which the output and input SWG sections 112, 122 are designed and fabricated into the output lens 110 and the input lens 120 are described in greater detail herein below.

Generally speaking, an input array of beams carrying digital or analog information is imaged onto the receivers 104 from the sources 102. The sources 102 and the receivers 104 may comprise, for instance, ends of respective optical fibers or other optical transmission and media, optical engines, etc. The input array of beams originating from the sources 102 are to be directed to respective ones of the receivers 104 by the output and input SWG sections 112, 122 in the respective lenses 110 and 120. Although the receivers 104 have been depicted as being arranged substantially in ridge with the sources 102, it should be understood that the positions of the receivers 104 may be offset in either or both of the y and z directions.

By way of example, the array of receivers 116 may share a common plane as the array of sources 114 or to otherwise receive light beams in the same direction as the light beams are emitted from the sources 102. In this example, the SWG sections 122 of the input lens 120 are designed and fabricated to reflect the light beams to therefore direct the light beams back in the x direction.

An example of a manner in which the light beams are directed to the receivers 104 is provided in FIG. 1B, which shows a simplified side view of the optical shuffle system 100 depicted in FIG. 1A, according to an example. To simplify the illustration in FIG. 1B, the sources 102 have been depicted as being contained in respective vertically arranged source clusters 130a-130d and the receivers 104 have been depicted as being contained in respective vertically arranged receiver clusters 140a-140d. It should therefore be understood that the sources 102 and the receivers 104 may be arranged in various other configurations without the parting from a scope of the optical shuffle system 100 depicted in FIG. 1B.

As shown in FIG. 1B, beams of light 132a-132n may be outputted from each of the sources 102 and directed into respective ones of the output SWG sections 112 in the output lens 110. As described in greater detail herein below, the respective output SWG sections 112 have various physical characteristics that cause the light beams 132a-132n to undergo phase shifts as the light beams 132a-132n are transmitted through the respective output SWG sections 112. More particularly, at least some of the output SWG sections 112 have different physical characteristics with respect to each other to cause the light beams 132a-132n to be directed into different directions with respect to each other.

As also described in greater detail herein below, the respective input SWG sections 122 contained in the input lens 120 have various physical characteristics that cause the light beams 132a-132n to undergo phase shifts as the light beams 132a-132n impinge the respective input SWG sections 122. More particularly, at least some of the respective input SWG sections 122 have different physical characteristics with respect to each other to cause the light beams 132a-132n to be directed into different directions with respect to each other and into respective ones of the receivers 104.

The output SWG sections 112 and the input SWG sections 122 are thus designed and fabricated to have physical characteristics that cause each light beam 132a-132n emitted from the sources 102 to be directed to one of the receivers 104. For instance, the output SWG sections 112 and the input SWG sections 122 have physical characteristics that cause the light beams 132a-132d emitted from the sources 102 in the first source cluster 130a to be directed to a respective target receiver 104 in each of the receiver clusters 140a-140d. Likewise, the output SWG sections 112 and the input SWG sections 122 have physical characteristics that cause the light beams 132e-132n to be emitted from the sources 102 in the other source clusters 130b-130d to be directed to respective target receivers 104 in each of the receiver clusters 140a-140d. The output SWG sections 112 and the input SWG sections 122 may be designed and fabricated to cause various ones of the light beams 132a-132n to be deviated in either or both of the y and z directions.

In one regard, various ones of the output SWG sections 112 are designed and fabricated to have different physical characteristics with respect to each other to cause different amounts of deviation to occur in the light beams 132a-132n being transmitted through the output SWG sections 112. That is, the output SWG section 112 positioned in the output optical path of the source 102 that emitted the beam of light 132c has physical characteristics that cause the beam of light 132c to have a greater amount of deviation than that of the output SWG section 112 positioned in the output optical path of the source 102 that emitted the beam of light 132b. The input SWG sections 122 are likewise designed and fabricated to cause different amounts of deviation to occur in the light beams 132a-132n that impinge upon the input SWG sections 122.

By way of example, and as shown in FIG. 1B, the beam of light 132a emitted from a first one of the sources 102 in the first source cluster 130a is to be emitted to a first one of the receivers 104 in the first receiver cluster 140a. In this regard, the output SWG section 112 positioned in the optical path of the beam of light 132a generally operates to collimate the beam of light 132a without substantially changing the axis at which the beam of light 132a is emitted from the source 102. In addition, the input SWG section 122 positioned in the optical path of the beam of light 132a transmitted through the about-identified output SWG section 112 operates to focus the beam of light 132a without substantially changing the axis at which the beam of light 132a is transmitted through the input SWG section 122. The beam of light 132a is then directed into the first one of the receivers 104.

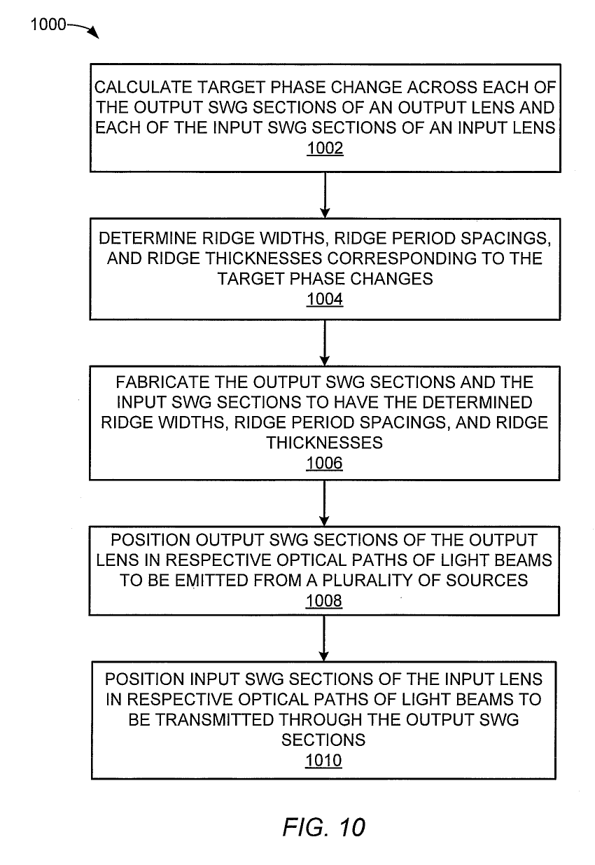

An example of a manner in which the aforementioned output SWG section 112 collimates the beam of light 132a while substantially maintaining the beam of light 132a along an axis 134 of the output SWG section 112 is depicted in FIG. 1C. Similarly, the diagram depicted in FIG. 10, when viewed from right to left, also depicts an example in which the input SWG section 122 focuses the beam of light 132a while substantially maintaining the beam of light 132a along the axis 134 of an input SWG section 122 and onto a receiver 104.

As another example, the beam of light 132b emitted from a second one of the sources 102 in the first source cluster 130a is to be emitted to a first one of the receivers 104 in the second receiver cluster 140b. In this regard, the output SWG section 112 positioned in the optical path of the beam of light 132b generally operates to both collimate the beam of light 132b and change the direction in which the beam of light 132b is transmitted. As shown in FIG. 1B, the aforementioned output SWG section 112 has physical characteristics that cause the beam of light 132b to be redirected in at least the z direction, such that, the beam of light 132b is directed towards the input SWG section 122 that is in the optical path of the first one of the receivers 104 in the second receiver cluster 140b. In addition, the aforementioned input SWG section 122 has physical characteristics that both focus the beam of light 132b and cause the focused beam of light 132b to be directed to the aforementioned receiver 104.

An example of a manner in which the aforementioned output SWG section 112 collimates the beam of light 132b and changes the direction of the beam of light 132b, such that the beam of light 132b is off from the axis 134 of the output SWG section 112 is depicted in FIG. 1D. Similarly, the diagram depicted in FIG. 1D, when viewed from right to left, also depicts an example in which an input SWG section 122 focuses the beam of light 132b while changing the direction of the beam of light 132b along the axis 134 of an input lens 120 and onto a receiver 104.

Although the output SWG sections 112 and the input SWG sections 122 have been depicted as being formed in discreet locations on the respective output and input lenses 110, 120, it should be understood that additional sections of the output lenses and the input lenses 110, 120 may be formed of SWG sections without departing from a scope of the optical shuffle system 100. Thus, for instance, substantially the entire surface area, for instance, greater than about 75% of the surface area, of the output lens 110 may be include sub-wavelength gratings.

In addition, or alternatively, one or both of the output and input lenses 110 and 120 and the array of sources 114 are movable with respect to each other. In this example, when the relative position of the one or more of the output and input lenses 110 and 120 and the array of sources 114 changes, different sets of output and input SWG sections 112, 122 will be positioned in the optical paths of the beams of light 132a-132n. In addition, the different sets of output and input SWG sections 112, 122 have different physical characteristics, thus causing the beams of light 132a-132n transmitted through the output SWG sections 112 to be directed into different directions. In one regard, therefore, different receivers 104 may receive light beams from different sources 102 simply by moving the output lens 110. Alternatively, however, this may be accomplished by replacing at least the output lens 110 with an output lens 110 having output SWG sections 112 that have different physical characteristics from those of the replaced output lens 110.

According to a particular example, and as shown in FIG. 1E, the output lens 110 is attached to an actuator 150 to move the output lens 110 in either or both of the y- and z-directions, as denoted by the arrow 152. Movement of the output lens 110 generally causes the direction of a beam of light 132a emitted through the output SWG section 112 to vary, as denoted by the arrow 154. As such, the focal point of the beam of light 132a as depicted in FIG. 1E may move in either or both of the directions indicated by the arrows 160 to thereby cause the beam of light 132a to impinge upon difference ones of the receivers 104 and/or different sections of the input lens 120. In various examples, the input lens 120 may instead or additionally be movable through operation of an actuator 150. In any regard, the actuator may comprise, for instance, an encoder, a microelectromechanical system (MEMS), etc.

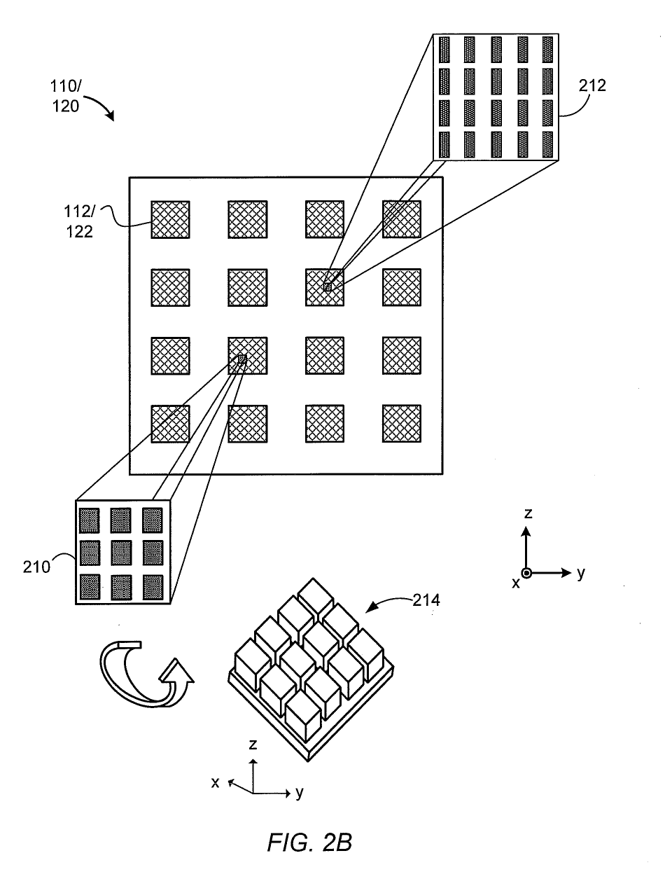

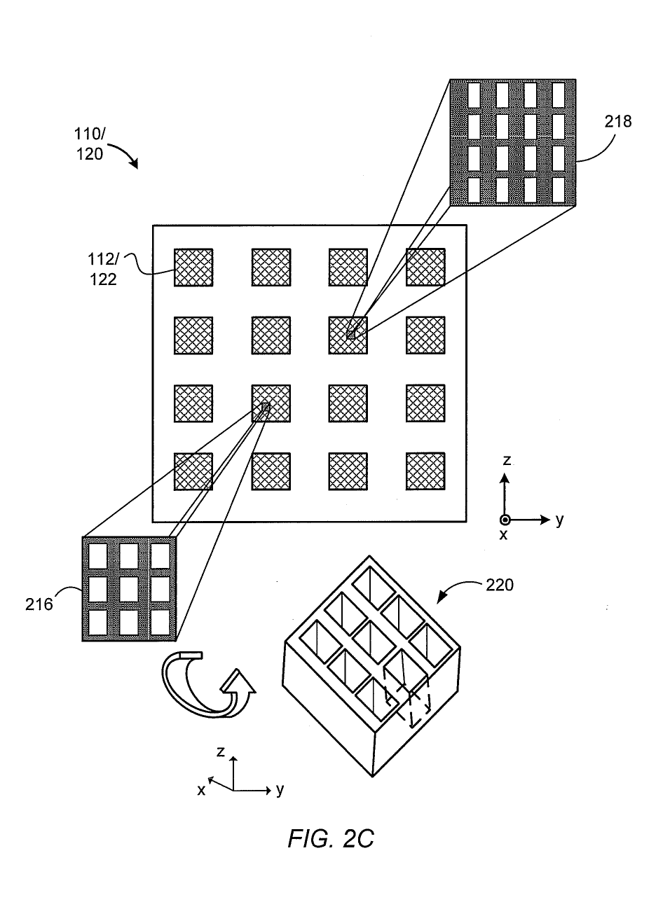

FIG. 2A shows a frontal view of a lens 110/120 composed of a plurality of SWG sections 112/122 formed as one dimensional sub-wavelength grating patterns in the lens 110/120 according to an example. The lens 110/120 depicted in FIG. 2A may comprise either or both of the output lens 110 and the input lens 120 and the SWG sections 112/122 may comprise either or both of the output SWG sections 112 and the input SWG sections 122. Each of the one-dimensional grating patterns forming the SWG sections 112/122 is composed of a number of sections containing one-dimensional grating sub-patterns arranged to transmit light at differing phase shifts, for instance, to collimate light, to re-direct light, etc. In the example depicted in FIG. 2A, three grating sub-patterns 201-203 of three different lenses 112/122 are enlarged.

As shown in the enlargements of the grating sub-patterns 201-203, each grating sub-pattern 201-203 comprises a number of regularly spaced wire-like portions of material called “ridges”. The ridges are depicted as extending in the z-direction and are periodically spaced in the y-direction. In other examples, the ridge spacing may be continuously varying to produce a desired pattern in the beams of light transmitted through the respective SWG sections 112/122. FIG. 2A also includes an enlarged end-on view 204 of the grating sub-pattern 202, which shows that the ridges 206 are disposed on a surface of a substrate 207 and are separated by grooves 208. According to an example, the ridges 206 are composed of a relatively higher refractive index material than the substrate 207. For example, the ridges 206 may be composed of silicon (“Si”) and the substrate 207 may be composed of quartz or silicon dioxide (“SiO₂”), or the ridges 206 may be composed of gallium arsenide (“GaAs”) and the substrate 207 may be composed of aluminum gallium arsenide (“AlGaAs”) or aluminum oxide (“Al₂O₃”), etc.

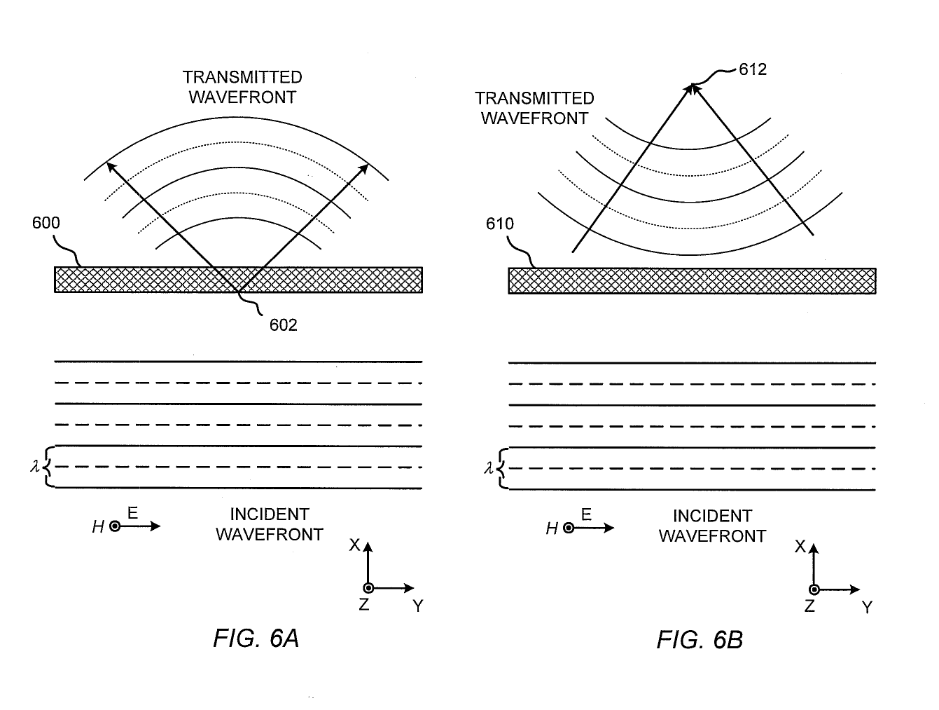

Each sub-pattern of ridges 206 is characterized by a particular periodic spacing of the ridges and by the ridge width in the y-direction. For example, the sub-pattern 201 comprises ridges of width w₁ separated by a period p₁, the sub-pattern 202 comprises ridges with width w₂ separated by a period p₂, and the sub-pattern 203 comprises ridges with width w₃ separated by a period p₃. According to an example, each sub-pattern of ridges 206 includes multiple ridge widths and periods. In addition, each sub-pattern is designed and fabricated to shape light transmitted through (or reflected by) the sub patterns so as to focus/collimate and deviate the light. Moreover, each sub-pattern is designed and fabricated to transform a curved wavefront (for instance, as shown in FIG. 6B) into a plane wavefront. However, the direction of the normal to the wavefronts will not be in general orthogonal to the plane of the SWG 610 shown in FIG. 6B. Similarly, other patterns are designed and fabricated to generate a plane wavefront incident at an angle different from the normal and to focus the light.

The grating sub-patterns 201-203 form SWGs that preferentially transmit incident light polarized in one direction, i.e., the y-direction, provided the periods p₁, p₂, and p₃ are smaller than the wavelength of the incident light. For example, the ridge widths may range from approximately 100 nm to approximately 800 nm and the periods may range from approximately 200 nm to approximately 1 μm depending on the wavelength of the incident light. The light transmitted through a region acquires a phase φ determined by the ridge thickness t, and the duty cycle η defined as:

$$η = \frac{w}{p}$$

where w is the ridge width and p is the period spacing of the ridges.

Each of the SWG sections 112/122 may apply a particular phase change to refract light while maintaining sections that have a relatively low refraction level and sections that have a relatively high refraction level to thereby transmit the light in a predetermined pattern. The one-dimensional sub-wavelength gratings of the SWG sections 112/122 may refract the y-polarized component or the z-polarized component of the incident light by adjusting the period, ridge width and ridge thickness of the ridges. For example, a particular period, ridge width and ridge thickness may be suitable for refracting the y-polarized component but not for reflecting the z-polarized component; and a different period, ridge width and ridge thickness may be suitable for refracting the z-polarized component but not for refracting the y-polarized component. In this regard, particular periods, ridge widths and ridge thicknesses may be selected for various areas of the SWG sections 112/122 to thereby control the patterns of the light beams transmitted through the SWG sections 112/122.

Instead of one-dimensional gratings, the SWG sections 112/122 may be formed of SWGs having two-dimensional, non-periodic grating patterns. FIGS. 2B-2C show frontal views of two example lenses 110/120 having SWG sections 112/122 that are formed of two-dimensional sub-wavelength grating patterns, according to two examples. In the example of FIG. 2B, the sub-wavelength gratings forming the SWG sections 112/122 are composed of posts rather ridges separated by grooves. The duty cycle and period may be varied in the y- and z-directions. Enlargements 210 and 212 show two different post sizes. FIG. 2B includes an isometric view 214 of posts comprising the enlargement 210. It should be understood that posts having other shapes, such as, square, circular, elliptical or any other suitable shape. In the example of FIG. 2C, the sub-wavelength grating patterns forming the SWG sections 112/122 are composed of holes rather than posts. Enlargements 216 and 218 show two different rectangular-shaped hole sizes. The duty cycle may be varied in the y- and z-directions. FIG. 2C includes an isometric view 220 comprising the enlargement 216. Although the holes shown in FIG. 2C are rectangular shaped, in other examples, the holes may be square, circular, elliptical or any other suitable shape.

In other examples, the ridge spacing, thickness, and periods may be continuously varying in both one- and two-dimensional grating patterns to produce a desired effect on the refracted light.

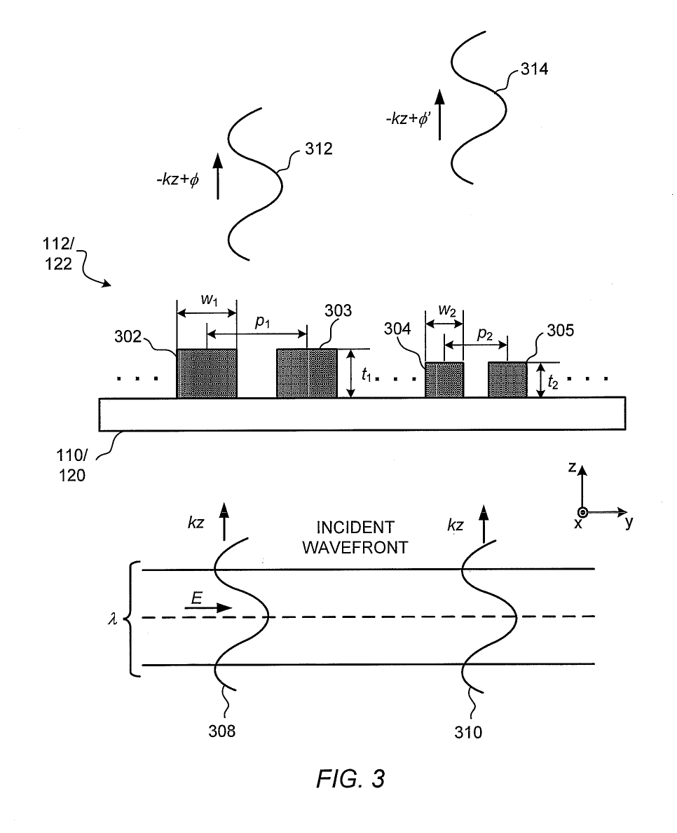

FIG. 3 shows a cross-sectional view of a plurality of ridges 302-305 of a sub-wavelength grating sub-pattern in a SWG section 112/122 of a lens 110/120, according to an example. FIG. 3, more particularly, depicts the phase acquired by light transmitted through the ridges 302-305 of the SWG section 112/122. According to an example, the ridges 302 and 303 comprise ridges in a first grating sub-pattern of the SWG section 112/122 and ridges 304 and 305 comprise ridges in a second grating sub-pattern of the SWG section 112/122. The thickness t₁ of the ridges 302 and 303 is greater than the thickness t₂ of the ridges 304 and 305, and the duty cycle η₁ associated with the ridges 302 and 303 is also greater than the duty cycle η₂ associated with the ridges 304 and 305. Light polarized in the y-direction and incident on the ridges 302-305 becomes trapped by the ridges 302 and 303 for a relatively longer period of time than the portion of the incident light trapped by the ridges 304 and 305. As a result, the portion of light transmitted through the ridges 302 and 303 acquires a larger phase shift than the portion of light transmitted through the ridges 304 and 305. As shown in the example of FIG. 3, the incident waves 308 and 310 strike the ridges 302-305 with approximately the same phase, but the wave 312 transmitted through the ridges 302 and 303 acquires a relatively larger phase shift φ than the phase φ′ (i.e., φ>φ′) acquired by the wave 314 transmitted through the ridges 304 and 305.

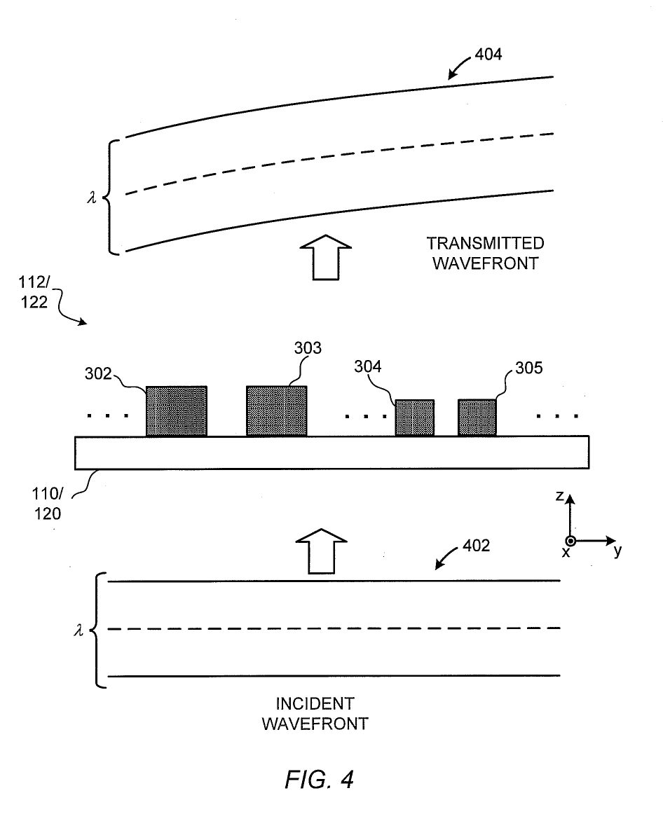

FIG. 4 shows a cross-sectional view of the ridges 302-305 depicted in FIG. 3 revealing how the transmitted wavefront changes according to an example. As shown in the example of FIG. 4, incident light with a substantially uniform wavefront 402 strikes the ridges 302-305 producing transmitted light with a curved transmitted wavefront 404. The curved transmitted wavefront 404 results from portions of the incident wavefront 402 interacting with the ridges 302 and 303 with a relatively larger duty cycle η₁ and thickness than portions of the same incident wavefront 402 interacting with the ridges 304 and 305 with a relatively smaller duty cycle η₂ and thickness t₂. The shape of the transmitted wavefront 404 is consistent with the larger phase acquired by light striking the ridges 302 and 303 relative to the smaller phase acquired by light striking the ridges 304 and 305. By controllably varying the duty cycle and thicknesses of the ridges 302-305 with respect to each other, the transmitted wavefront may be controlled to, for instance, collimate and re-direct light beams.

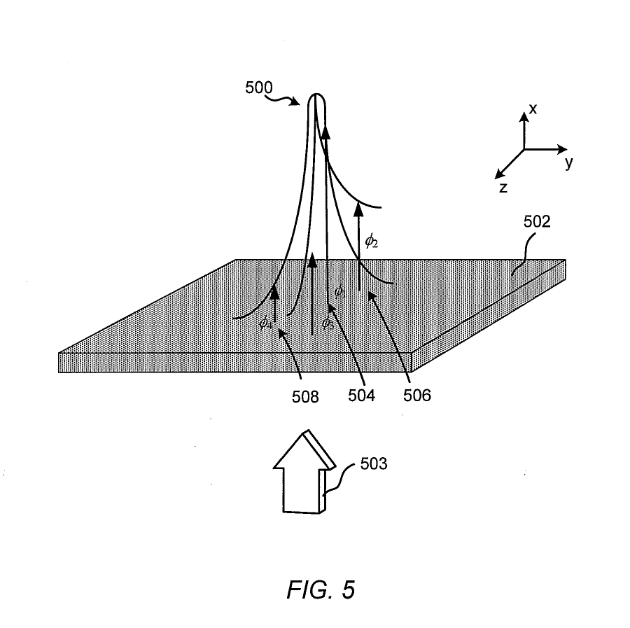

FIG. 5 shows an isometric view of a phase change contour map 500 produced by a particular grating pattern of a SWG 502, according to an example. The contour map 500 represents the magnitude of the phase change acquired by light 503 transmitted through a SWG 502. In the example shown in FIG. 5, the grating pattern of the SWG 502 produces a contour map 500 with the largest magnitude in the phase acquired by the light 503 transmitted around the center of the SWG 502, with the magnitudes of the phases acquired by transmitted light decreasing away from the center of the sub-wavelength grating 502. For example, light transmitted through a sub-pattern 504 acquires a phase of φ₁, and light transmitted through a sub-pattern 506 acquires a phase of φ₂. Because φ₁ is much larger than φ₂, the light transmitted through the sub-pattern 506 acquires a much larger phase than the light transmitted through the sub-pattern 508.

The phase change in turn shapes the wavefront of light transmitted through the sub-wavelength grating 502 into a desired pattern. For example, as described above with reference to FIGS. 3 and 4, ridges having a relatively larger duty cycle produce a larger phase shift in transmitted light than ridges having a relatively smaller duty cycle. As a result, a first portion of a wavefront transmitted through ridges having a first duty cycle lags behind a second portion of the same wavefront transmitted through a different set of ridges having a second relatively smaller duty cycle. According to an example, the SWG 502, which may comprise a portion of a SWG section 112/122, is patterned to have portions of varying levels of phase change to ultimately shape of the transmitted wavefront of the beams of light 132a-132n as discussed above with respect to FIGS. 1A-1D.

FIG. 6A shows a cross-sectional view of a SWG 600 that is designed and fabricated to diverge light as if the light emanated from a focal point 604 according to an example. In the example of FIG. 6A, the SWG 600 has a grating pattern so that incident light polarized in the y-direction is transmitted with a wavefront corresponding to diverging the transmitted light from the focal point 602. On the other hand, FIG. 6B shows a cross-sectional view of a SWG 610 that is designed and fabricated to focus light onto a focal point 612 according to an example. In the example of FIG. 6B, the SWG 610 has a grating pattern so that incident light polarized in the y-direction is transmitted with a wavefront corresponding to light directed to the focal point 612.

According to an example, various manners in which the period and duty cycle may be varied to design and fabricate sub-wavelength grating patterns described in U.S. Patent Application Publication No. 2011/0261856 may be employed to design and fabricate the sub-wavelength grating patterns forming the SWG sections 112/122 disclosed herein.

Various manners in which the SWG sections 112/122 may be designed to introduce a desired phase front for transmitted light will now be described. Two examples of SWG sections 112/122 designed to produce particular phase changes in transmitted light are described with respect to FIG. 5. A first method includes determining a transmission profile for the SWG layer 502. The transmission coefficient is a complex valued function represented by:

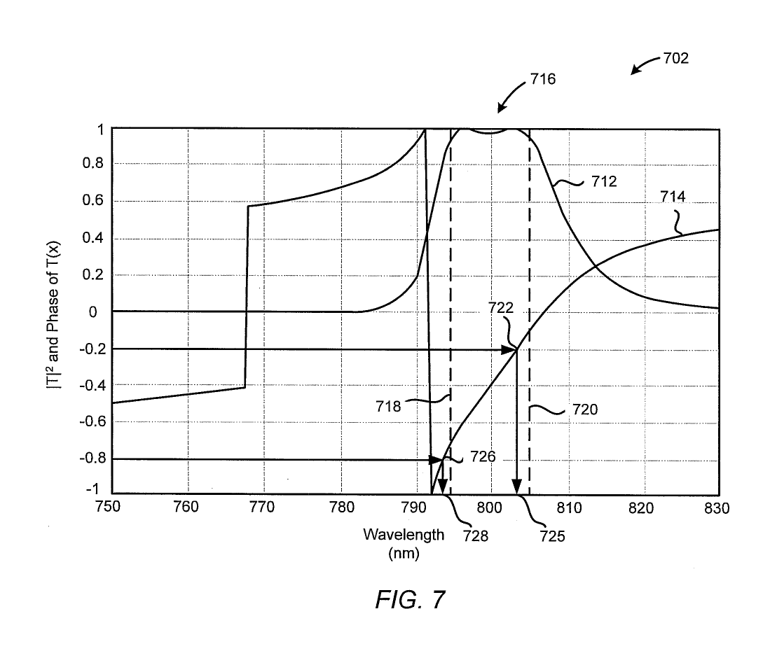

T(λ)=\sqrt{T_{P}(λ)e^{iφ(λ)}}

where T_{P}(λ) is the power transmittance of the SWG section 112/122, and φ(λ) is the phase shift or change produced by the SWG section 112/122. FIG. 7 shows a plot 702 of transmittance and phase shift simulation results over a range of incident light wavelengths for a SWG section 112/122 having a particular sub-wavelength grating pattern, according to an example. In the plot 702, the curve 712 corresponds to the transmittance T(λ) and the curve 714 corresponds to the phase shift φ(λ) produced by the SWG section 112/122 for the incident light over the wavelength range of approximately 750 nm to approximately 830 nm. The transmittance and phase curves 712 and 714 represent expected operation of the SWG section 112/122 and maybe obtained using the application “MIT Electromagnetic Equation Propagation” (“MEEP”) simulation package to model electromagnetic systems (ab-initio.mit.edu/meep/meep-1.1.1.tar.gz), COMSOL Multiphysics® which is a finite element analysis and solver software package that can be used to simulate various physics and engineering applications (www.comsol.com), or other suitable simulation application. The curve 712 reveals a broad spectral region of high transmittance 716. However, the curve 714 reveals that the phase of the reflected light varies across the entire high-reflectivity spectral region between dashed-ridges 718 and 720.

The plot 702 may be used to uniformly adjust geometric parameters of the entire SWG section 112/122 in order to produce a desired change in the transmitted wavefront. When the spatial dimensions of the entire SWG section 112/122 are changed uniformly by a factor α, the transmission coefficient profile remains substantially unchanged, but with the wavelength axis scaled by the factor λ. In other words, when a SWG section 112/122 has been designed with a particular transmission coefficient T₀ at a free space wavelength λ₀, a new SWG section with the same transmission coefficient at a different wavelength λ may be designed by multiplying the SWG section physical characteristics (e.g., geometric parameters), such as the ridge period spacing, ridge thickness, and ridge width, by the factor α=λ/λ₀, giving T(λ)=T₀(λ/α)=T₀(λ₀).

In addition, a SWG section may be designed so that the SWG section has a |T(λ)→1|, but with a spatially varying phase and for a fixed resonator length, by scaling the parameters of the SWG section within the high-transmission spectral window 716. Suppose that introducing a phase φ(x, y) to light transmitted through a point of a SWG section with transverse coordinates (x, y) is desired. Near the point (x, y), a nonuniform grating with a slowly varying scale factor α(x, y) behaves locally as though the SWG section was configured with a periodic grating with a transmission coefficient T₀(λ/a). Thus, for a SWG section with a certain phase φ₀ at some wavelength λ₀, choosing a local scale factor α(x, y)=λ/λ₀ gives φ(x, y)=φ₀ at the operating wavelength λ. For example, suppose that introducing a phase of approximately −0.2π on a portion of the light transmitted through a point (x, y) on a SWG section is desired, but current design of the SWG section introduces a phase of approximately −0.8λ. Referring to the plot 702, the desired phase φ₀=−22π corresponds to the point 722 on the curve 714 and the wavelength λ₀≈803 nm 725, and the phase −0.8π associated with the point (x, y) corresponds to the point 726 on the curve 714 and the wavelength λ≈794 nm. Thus the scale factor is α(x, y)=λ/λ₀=794/803=0.989, and the geometric dimension of the SWG section, such as the thickness, ridge period spacing, and ridge width at the point (x, y) may be adjusted by multiplying by each of these parameters by the factor α in order to obtain the desired transmission phase φ₀=−22π at the point (x, y) for the operating wavelength λ≈794 nm.

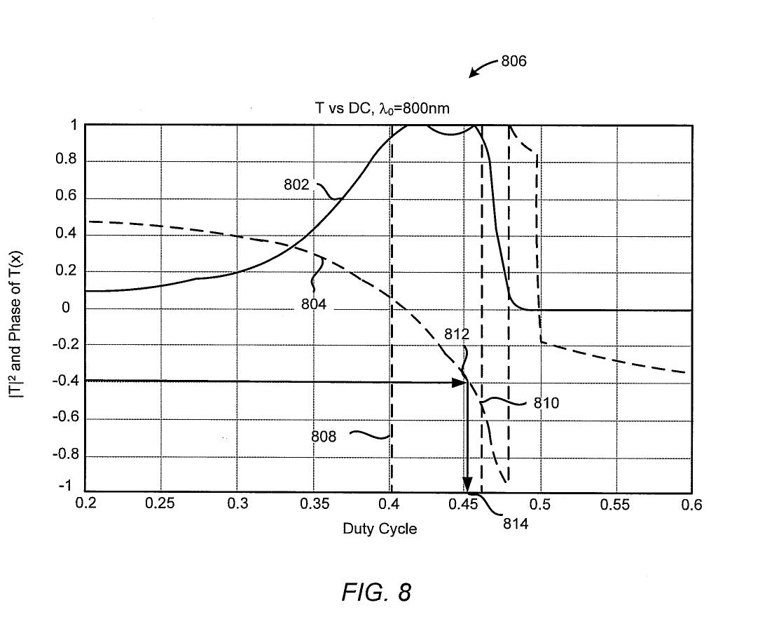

The plot of transmittance and phase shift versus a range of wavelengths shown in FIG. 7 represents one way in which parameters of a SWG section 112/122 may be selected in order to introduce a particular phase to light transmitted through a particular point of the SWG section 112/122. In certain examples, producing a desired phase variation in transmitted light through a SWG section 112/122 may be accomplished by changing the duty cycle of portions of the SWG section 112/122. FIG. 8 shows a plot of transmittance and phase shift as a function of the sub-wavelength grating layer duty cycle for light with a wavelength of approximately 800 nm, according to an example.

In FIG. 8, the curve 802 corresponds to the transmittance T(2) and the curve 804 corresponds to the phase shift φ(λ) produced by a SWG section 112/122 for the incident light with the wavelength of approximately 800 nm over a range of duty cycles from approximately 0.2π to approximately 0.6π. The transmittance and phase curves 802 and 804 may be determined using MEEP, COMSOL Multiphysics®, etc. The curve 802 reveals a broad spectral region of high transmittance 806. However, curve 804 reveals that the phase of the reflected light varies across the entire high transmittance region 806 between dashed-ridges 808 and 810 as a function of the duty cycle of the sub-wavelength grating layer. Thus, a lens may be operated to transmit light with the wavelength 800 nm, with a high transmittance 806, and with a desired phase shift by configuring a corresponding region of the SWG section 112/122 with a duty cycle corresponding to the desired phase shift based on the curve 804. For example, suppose that it is desired to transmit light through a particular region of the SWG section 112/122 with a phase shift of −0.4π. A phase shift of −0.47π corresponds to a point 812 on the curve 804 and to a duty cycle of 0.451 (814). Thus, in order to introduce the phase shift of −0.4π to light transmitted through this region, the corresponding region of the SWG section 112/122 alone may be configured with the duty cycle of 0.451 (814).

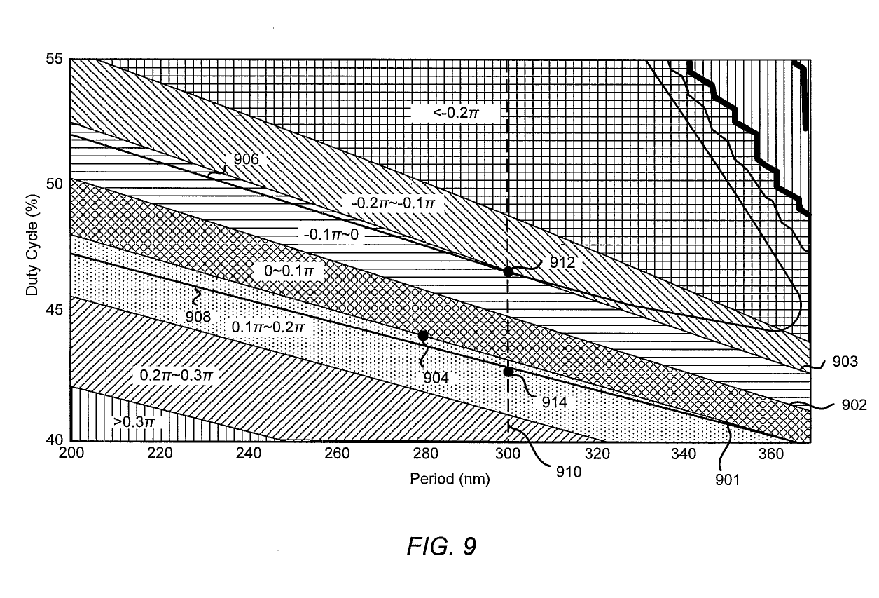

In still other examples, variations in the phase of light transmitted through a SWG section 112/122 may be accomplished as a function of ridge period spacing and duty cycle of the SWG section 112/122. FIG. 9 shows a contour plot of phase variation as a function of period and duty cycle obtained according to an example using, for instance, MEEP, COMSOL Multiphysics®, etc. Contour ridges, such as contour ridges 901-903, each corresponds to a particular phase acquired by light transmitted through a SWG section 112/122 with the sub-wavelength grating layer 502 configured with a period and duty cycle lying anywhere along the contour. The phase contours are separated by 0.1π rad. For example, contour 901 corresponds to periods and duty cycles that apply a phase of 0.1π rad to transmitted light. Phases between 0.1π rad and 0.0 rad are applied to light transmitted through a region of the SWG section 112/122 that has periods and duty cycles that lie between contours 901 and 902. A point (p,η) 904 corresponds to a grating period of 280 nm and 44% duty cycle. A sub-region of the SWG section 112/122 with a period and duty cycle corresponding to the point 904 introduces the phase φ₀=0.1π rad to light transmitted through the sub-region of the lens. FIG. 9 also includes two transmission contours 906 and 908 for 95% transmission overlain on the phase contour surface. Points (p,η,φ) that lie anywhere between the contours 906 and 908 have a minimum transmission of 95%.

The points (p,η,φ) represented by the phase contour plot may be used to select periods and duty cycles for a SWG section 112/122 that may be operated as a particular type of lens with a minimum transmission, as described below in the next subsection. In other words, the data represented in the phase contour plot of FIG. 9 may be used to configure the grating sub-patterns of a SWG section 112/122 so that the SWG section 112/122 may be operated to collimate and redirect light beams as discussed above. In certain examples, the period or duty cycle may be fixed while the other parameter is varied to configure the SWG section 112/122. In other examples, both the period and duty cycle may be varied to configure the SWG section 112/122.

Various additional manners in which the sub-wavelength grating layers 502 forming the lenses 112/122 may be designed and fabricated are described in the U.S. Ser. No. 13/384,725 application for patent.

FIG. 10 shows a flow diagram of a method 1000 for fabricating an optical shuffle system, according to an example. It should be understood that the method 1000 is a generalized illustration and that additional steps may be added and/or existing steps may be modified or removed without departing from the scope of the method 1000.

At block 1002, a target phase change across each of the plurality of output SWG sections 112 is calculated, in which each of the target phase changes corresponds to a desired wavefront shape in a beam of light transmitted through each of the plurality of output SWG sections 112. More particularly, for instance, the levels of deviation in the directions of the light beams 132a-132n being transmitted through the output SWG sections 112 may be determined and the target phase change across each of the output SWG sections 112 to achieve the respective levels of deviation through the output SWG sections 112 may be calculated. Thus, for instance, the target phase changes across the output SWG sections 112 that cause the light beams 132a-132n to be directed to the respective target destinations 104 may be calculated at block 1002.

In addition, at block 1002, a target phase change across each of the plurality of input SWG sections 122 may be calculated, in which each of the target phase changes corresponds to a desired wavefront shape in a beam of light directed by each of the plurality of input SWG sections 122. More particularly, for instance, the levels of deviation in the directions of the light beams 132a-132n being directed by the input SWG sections 122 may be determined and the target phase change across each of the input SWG sections 122 to achieve the respective levels of deviation directed by the input SWG sections 122 may be calculated. Thus, for instance, the target phase changes across the input SWG sections 122 that cause the light beams 132a-132n to be directed to the respective target destinations 104 may be calculated at block 1002.

At block 1004, ridge widths, ridge period spacings, and ridge thicknesses corresponding to the target phase changes across the output SWG sections 112 and the input SWG sections 122 are determined. The ridge widths, ridge period spacings, and ridge thicknesses corresponding to the target phase changes may be determined in any of the manners discussed above.

At block 1006, the output SWG sections 112 and the input SWG sections 122 are fabricated to have the ridge widths, ridge period spacings, and ridge thicknesses determined at block 1004. The output SWG sections 112 and the input SWG sections 122 are respectively fabricated on the output lens 110 and the input lens 120 through any suitable technique for forming the ridges and grooves. Thus, for instance, the ridges of the output SWG sections 112 and the input SWG sections 122 may be fabricated through use of reactive ion etching, focusing ion beam milling, nanoimprint lithography, etc. By way of particular example, the ridges of the respective output SWG sections 112 may be patterned directly on a first layer of material of the output lens 110. In addition, the ridges of the respective input SWG sections 122 may be patterned directly on a first layer of material of the input lens 120. As another example, an imprint mold on which is the ridges are defined is used to imprint the ridges into a first layer. Each of the output SWG sections 112 may be formed in the output lens 110 during a single fabrication operation. In addition, each of the input SWG sections 112 may be formed in the input lens 110 during a single fabrication operation.

According to an example, the calculation of the target phase changes at block 1002 and the determination of the ridge widths, ridge period spacings, and ridge thicknesses at block 1004 are performed by a computing device. In addition, the computing device may control a micro-chip design tool (not shown) to form the output SWG sections 112 in the output lens 110 and the input SWG sections 122 in the input lens 120.

At block 1008, the output SWG sections 112 of the output lens 110 are positioned in respective optical paths of light beams to be emitted from the plurality of sources 102. As discussed above, each of the output SWG sections 112 is to collimate and direct a light beam received from one of the plurality of sources 102 toward a target receiver 104 of the plurality of receivers 104.

At block 1010, the input SWG sections 112 of the input lens 120 are positioned in respective optical paths transmitted through the plurality of output SWG sections 112 and the plurality of receivers 104. As discussed above, each of the input SWG sections 122 is to focus and direct a light beam received from an output SWG section 112 into a target receiver.

Some or all of the operations set forth in the method 1000 may be contained as a utility, program, or subprogram, in any desired computer accessible medium. In addition, some of the operations set forth in the method 1000 may be embodied by machine readable instructions, which may exist in a variety of forms both active and inactive. For example, they may exist as source code, object code, executable code or other formats. Any of the above may be embodied on a non-transitory computer readable storage medium. Examples of non-transitory computer readable storage media include conventional computer system RAM, ROM, EPROM, EEPROM, and magnetic or optical disks or tapes. It is therefore to be understood that any electronic device capable of executing the above-described functions may perform those functions enumerated above.

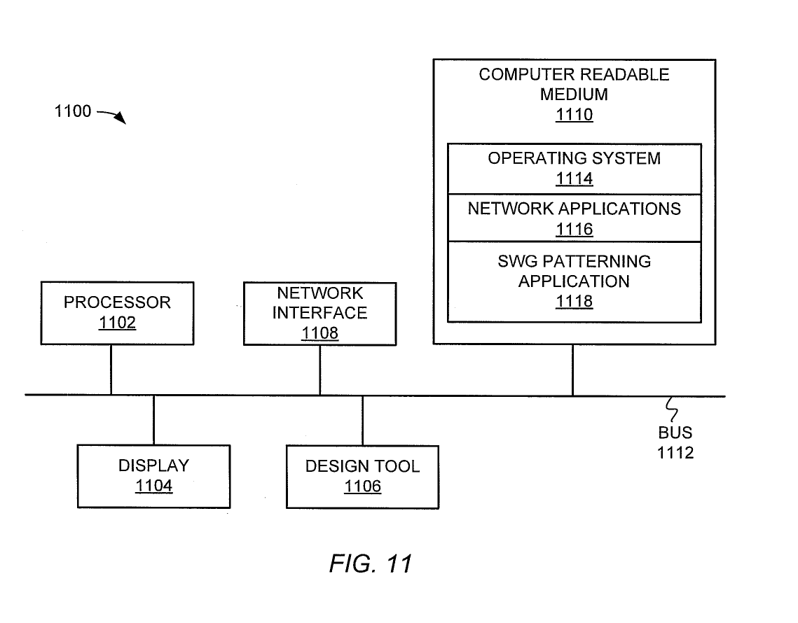

Turning now to FIG. 11, there is shown a schematic representation of a computing device 1100, which may be employed to perform various operations in the method 1000, according to an example. The device 1100 includes a processor 1102, such as a central processing unit; display device 1104, such as a monitor; a design tool interface 1106; a network interface 1108, such as a Local Area Network LAN, a wireless 802.11x LAN, a 3G mobile WAN or a WiMax WAN; and a computer-readable medium 1110. Each of these components is operatively coupled to a bus 1112. For example, the bus 1412 may be an EISA, a PCI, a USB, a FireWire, a NuBus, or a PDS.

The computer readable medium 1110 may be any suitable medium that participates in providing instructions to the processor 1102 for execution. For example, the computer readable medium 1110 may be non-volatile media, such as an optical or a magnetic disk. The computer-readable medium 1110 may also store an operating system 1114, such as Mac OS, MS Windows, Unix, or Linux; network applications 1116; and a SWG pattering application 1118. The network applications 1116 includes various components for establishing and maintaining network connections, such as software for implementing communication protocols including TCP/IP, HTTP, Ethernet, USB, and FireWire.

The SWG patterning application 1118 provides various machine readable instructions for calculating target phase changes and determining the ridge widths, ridge period spacings, and ridge thicknesses for the output SWG sections 112 and the input SWG sections 122 corresponding to the calculated target phase changes as discussed above with respect to the method 1000 in FIG. 10. In certain examples, some or all of the processes performed by the application 1118 may be integrated into the operating system 1114. In certain examples, the processes may be at least partially implemented in digital electronic circuitry, or in computer hardware, machine readable instructions (including firmware and software), or in any combination thereof, as also discussed above.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An optical shuffle system comprising:
a plurality of sources that are to output respective beams of light;
a plurality of receivers that are to receive respective beams of light, wherein the plurality of receivers are spaced apart from the plurality of sources;
an output lens formed of a plurality of output sub-wavelength grating (SWG) sections, wherein each of the plurality of output SWG sections is positioned in a respective output optical path of the plurality of sources; and
wherein each of the plurality of output SWG sections is to collimate and direct light received from respective ones of the plurality of sources toward respective ones of the plurality of receivers.

2. The optical shuffle system according to claim 1, wherein each of the plurality of output SWG sections is formed of a plurality of ridges having ridge widths, ridge thicknesses, and ridge period spacings selected to control phase changes in different portions of a beam of light transmitted through the output SWG section.

3. The optical shuffle system according to claim 2, wherein at least two of the plurality of output SWG sections comprise different ridge widths, ridge thicknesses, or ridge period spacings with respect to each other to transmit beams of light through the at least two of the plurality of output SWG sections into different directions with respect to each other.

4. The optical shuffle system according to claim 1, further comprising:
an input lens formed of a plurality of input SWG sections, wherein the plurality of input SWG sections are positioned in respective output optical paths of the plurality of output SWG sections, and wherein each of the plurality of input SWG sections is to focus and direct the light received from the plurality of output SWG sections into respective ones of the plurality of receivers.

5. The optical shuffle system according to claim 4, wherein each of the plurality of input SWG sections is formed of a plurality of ridges having ridge widths, ridge thicknesses, and ridge period spacings selected to control phase changes in different portions of a beam of light transmitted through the input SWG section.

6. The optical shuffle system according to claim 5, wherein at least two of the plurality of input SWG sections comprise different ridge widths, ridge thicknesses, or ridge period spacings with respect to each other to direct beams of light by the at least two of the plurality of input SWG sections into different directions with respect to each other.

7. The optical shuffle system according to claim 1, wherein the output lens comprises a substantially planar sheet of material, and wherein the plurality of output SWG sections are formed in a two-dimensional array on the substantially planar sheet of material.

8. The optical shuffle system according to claim 1, wherein the output lens is movable with respect to the plurality of sources to vary the plurality of output SWG sections that are positioned in respective output optical paths of the plurality of sources and to vary directions in which the respective beams of light outputted from the plurality of sources are directed.

9. The optical shuffle system according to claim 1, wherein the beams of light emitted from the plurality of sources are directed to a first subset of the plurality of receivers when the output lens is in a first position and wherein the beams of light from the plurality of sources are directed to a second subset of the plurality of receivers when the output lens is in a second position.

10. The optical shuffle system according to claim 1, wherein a SWG section of the plurality of output SWG sections is to receive the beam of light from one of the plurality of sources at a first angle, and wherein the SWG section is to collimate and diffract the received beam of light at a second angle that differs from the first angle in two dimensions.

11. A method for fabricating an optical shuffle system to communicate a plurality of light beams emitted from a plurality of sources to a plurality of receivers, said method comprising:
positioning a plurality of output sub-wavelength grating (SWG) sections of an output lens in respective optical paths of the light beams to be emitted from the plurality of sources, wherein each of the plurality of output SWG sections is to collimate and direct a light beam received from one of the plurality of sources toward a respective target receiver of the plurality of receivers; and
is positioning a plurality of input SWG sections of an input lens in respective optical paths of the light beams to be transmitted through the plurality of output SWG sections and the plurality of receivers, wherein each of the plurality of input SWG sections is to focus and direct a light beam received from an output SWG section of the plurality of output SWG sections into a respective target receiver of the plurality of receivers.

12. The method according to claim 11, further comprising:
calculating a target phase change across each of the plurality of output SWG sections, wherein each of the target phase changes corresponds to a desired wavefront shape in a respective beam of light transmitted through the plurality of output SWG sections;
determining ridge widths, ridge period spacings, and ridge thicknesses corresponding to the target phase changes for each of the plurality of output SWG sections; and
fabricating the plurality of output SWG sections to have the determined ridge widths, ridge period spacings, and ridge thicknesses in the output lens.

13. The method according to claim 11, further comprising:
calculating a target phase change across each of the plurality of input SWG sections, wherein each of the target phase changes corresponds to a desired wavefront shape in a respective beam of light directed by the plurality of input SWG sections;
determining ridge widths, ridge period spacings, and ridge thicknesses corresponding to the target phase changes for each of the plurality of input SWG sections; and
fabricating the plurality of input SWG sections to have the determined ridge widths, ridge period spacings, and ridge thicknesses in the input lens.

14. An optical shuffle system comprising:
an output lens formed of a plurality of output sub-wavelength grating (SWG) sections, wherein the plurality of output SWG sections are to be is positioned in respective output optical paths of light beams to be emitted from a plurality of sources of light beams;
an input lens formed of a plurality of input SWG sections, wherein the plurality of input SWG sections are to be positioned in respective output optical paths of the light beams to be transmitted through the plurality of output SWG sections, and wherein the plurality of input SWG sections are to focus and direct light beams received from the plurality of output SWG sections into respective receivers of the plurality of receivers, and
and wherein the plurality of output SWG sections and the plurality of input SWG sections are formed of predetermined patterns of ridges having various ridge widths, ridge period spacings, and ridge thicknesses corresponding to target phase changes across each of the plurality of output SWG sections and the plurality of input SWG sections.

15. The optical shuffle system according to claim 14, further comprising:
an actuator to reposition the output lens such that different ones of the output SWG sections are positioned in the respective optical paths of the light beams emitted from the plurality of sources when the output lens is repositioned.
